(19) United States
(12) Patent Application Publication
(10) Pub. No.: US 2009/0260970 A1
(43) Pub. Date: Oct. 22, 2009

(54) KEYSWITCH AND KEYBOARD

(75) Inventors: Lei Lung Tsai, Taipei County (TW); Yun Nien Chai, Tainan City (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: Darfon Electronics Corp., Taoyuan (TW)

(21) Appl. No.: 12/423,401

(22) Filed: Apr. 14, 2009

(30) Foreign Application Priority Data
Apr. 18, 2008 (TW) 097206684

(51) Int. Cl. H01H 13/70; H01H 13/705

(52) U.S. Cl. 200/5 A; 200/344

(57) ABSTRACT

The invention discloses a keyswitch and a keyboard which applies the keyswitch. The keyswitch includes a scissors-like supporting structure and a keycap. The scissors-like supporting structure includes a first arm member. The first arm member has a first axle. A retaining member is formed at the bottom of the keycap. The retaining member has a retaining portion and a block. The distal end of the retaining portion and the distal end of the block form an opening.

### BACKGROUND OF THE INVENTION

1. Field of the Invention

This invention relates to a keyswitch and a keyboard applies the keyswitch, and more particularly to a keyswitch and a keyboard of which the keycap can be vertically assembled to the scissor-like structure. Thus, the keyswitch and the keyboard can be semiautomatic assembled, the productivity can be increased, and the defective rate can be reduced.

2. Description of the Related Art

Nowadays, a keyboard is one of the necessary input devices to input characters or numbers while using a personal computer. In order to guide a keycap of a keyswitch to vertically move, a kind of scissors-like structure is usually disposed under the keycap, such that the force which a user applies on the keyswitch can be uniformed. Thus, no matter being applied at a side or a corner of the keyswitch, the force can be uniformly distributed on the whole keyswitch. So, the keyswitch becomes easy to be pressed and operated.

With the progresses of information and technologies, the applications of electronic products are more and more universal. For example, in order to comply with the developments of industry and commerce, notebook computers are therefore produced. The height of keyswitches of the keyboard of a portable electronic device (e.g., ultra-thin notebook computer) must meet the requirements of serious space limitations, so the scissors-like structure is indispensable.

Please refer to FIG. 1A and FIG. 1B. FIG. 1A is a schematic diagram illustrating the first stage of assembling a keycap 12 of a keyswitch 1 of a prior art to a scissors-like structure 14. FIG. 1B is a schematic diagram illustrating the second stage of assembling the keycap 12 of the keyswitch 1 of a prior art to the scissors-like structure 14. As shown in FIG. 1A and FIG. 1B, the keyswitch 1 includes a base plate 10, the keycap 12, and the scissors-like structure 14 which includes a first arm member 142 and a second arm member 144. The first arm member 142 and the second arm member 144 are disposed between the base plate 10 and the keycap 12 and pivotally connected to each other to be X-shaped. The steps of assembling the first arm member 142 and the second arm member 144 are firstly assembling a first lower pivotal axle 1422 of the first arm member 142 and a second lower pivotal axle 1442 of the second arm member 144 to a first lower pivotal member 102 and a second lower pivotal member 104 of the base plate 10 respectively, and then assembling the keycap 12 at the upper ends of the first arm member 142 and the second arm member 144.

As shown in FIG. 1A and FIG. 1B, a retaining member 122 having a lateral engagement entrance and a pivotal member 124 having a vertical engagement entrance are disposed at the bottom of the keycap 12. While assembling the keycap 12 to the scissors-like structure 14, the keycap 12 usually needs to be tilted substantially a angle firstly, and then a first upper pivotal axle 1424 of the first arm member 142 is embedded into the retaining member 122 having the lateral engagement entrance, as shown in FIG. 1A. Afterwards, the keycap 12 is pressed downward to embed the upper pivotal member 124 having the vertical engagement entrance with the second upper pivotal axle 1444 of the second arm member 144, as shown in FIG. 1B.

However, the foregoing traditional method of assembling the keycap to the scissors-like structure must be done by hand, which can not effectively increase the assembling speed and is easy to make mistakes while assembling. Moreover, the assembling force which is uneasy to be controlled may cause the damages of the keycap and the scissors-like structure in a keyswitch.

Accordingly, the major scope of the invention is to provide a keyswitch having a keycap, and a retaining member formed at the bottom of the keycap forms an opening. When the retaining member compresses toward the first axle with the opening, the first axle is limitedly and movably engaged to the retaining member by the elastic deformation of the block. Thereby, the problems caused by the traditional method of assembling the keycap to the scissors-like structure with a tilted angle can be solved. The invention not only can increase the yield rate and reduce the assembling cycle time, but also can benefit convenience and easiness of disassembling, repairing, and cleaning.

### SUMMARY OF THE INVENTION

An objective of the invention is to provide a keyswitch. The keyswitch includes a scissors-like supporting structure and a keycap. The scissors-like supporting structure includes a first arm member, and the first arm member has a first axle. A retaining member is formed at the bottom of the keycap, and the retaining member has a retaining portion and a block. The distal end of the retaining portion and the distal end of the block form an opening. When the retaining member compresses toward the first axle with the opening, the first axle is limitedly and movably engaged to the retaining member by the elastic deformation of the block.

Another objective of the invention is to provide a keyboard. The keyboard includes a plurality of keyswitches and a base plate. Each keyswitch includes a scissors-like supporting structure and a keycap. The scissors-like supporting structure includes a first arm member, and the first arm member has a first axle. A retaining member is formed at the bottom of the keycap, and the retaining member has a retaining portion and a block. The distal end of the retaining portion and the distal end of the block form an opening. The keyswitches are pivotally disposed on the base plate. When the retaining member of each keyswitch compresses toward the first axle with the opening, the first axle is limitedly and movably engaged to the retaining member by the elastic deformation of the block.

Accordingly, according to the keyswitch and the keyboard of the invention, a retaining member formed at the bottom of the keycap forms an opening. When the retaining member compresses toward the first axle with the opening, the first axle is limitedly and movably engaged to the retaining member by the elastic deformation of the block. Thereby, the problems caused by the traditional method of assembling the keycap to the scissors-like structure with a tilted angle can be solved. The invention not only can increase the yield rate and reduce the assembling cycle time, but also can benefit convenience and easiness of disassembling, repairing, and cleaning.

The advantage and spirit of the invention may be understood by the following recitations together with the appended drawings.

### BRIEF DESCRIPTION OF THE APPENDED DRAWINGS

FIG. 1A is a schematic diagram illustrating the first stage of assembling a keycap of a keyswitch of a prior art to a scissors-like structure.

FIG. 1B is a schematic diagram illustrating the second stage of assembling the keycap of the keyswitch of a prior art to the scissors-like structure.

FIG. 2A is a schematic diagram illustrating the first stage of assembling a keycap of a keyswitch to a scissors-like structure according to an embodiment of the invention.

FIG. 2B is a schematic diagram illustrating the second stage of assembling the keycap of the keyswitch to the scissors-like structure according to an embodiment of the invention.

FIG. 2C is a partial view illustrating the keycap in FIG. 2A.

FIG. 3 is a schematic diagram illustrating a keyboard according to an embodiment of the invention.

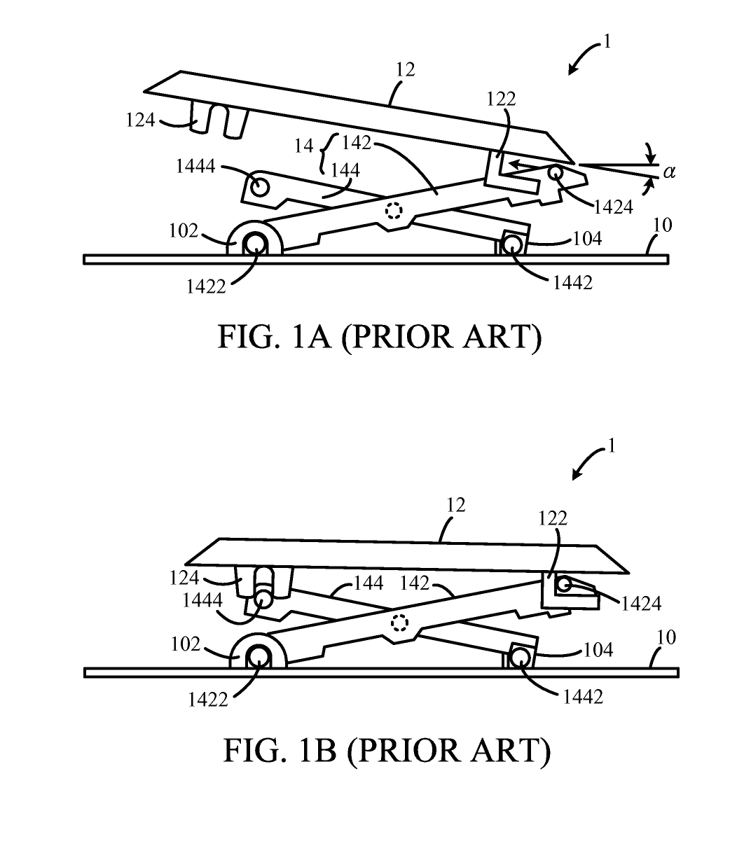

### DETAILED DESCRIPTION OF THE INVENTION

The invention is to provide a keyswitch and a keyboard applies the keyswitch, and more particularly to a keyswitch and a keyboard of which the keycap can be vertically assembled to the scissor-like structure. Thus, the keyswitch and the keyboard can be semiautomatic assembled, the productivity can be increased, and the defective rate can be reduced. The functions of the foregoing electronic apparatuses are well known and can be easily applied, so they will not be discussed detailed here.

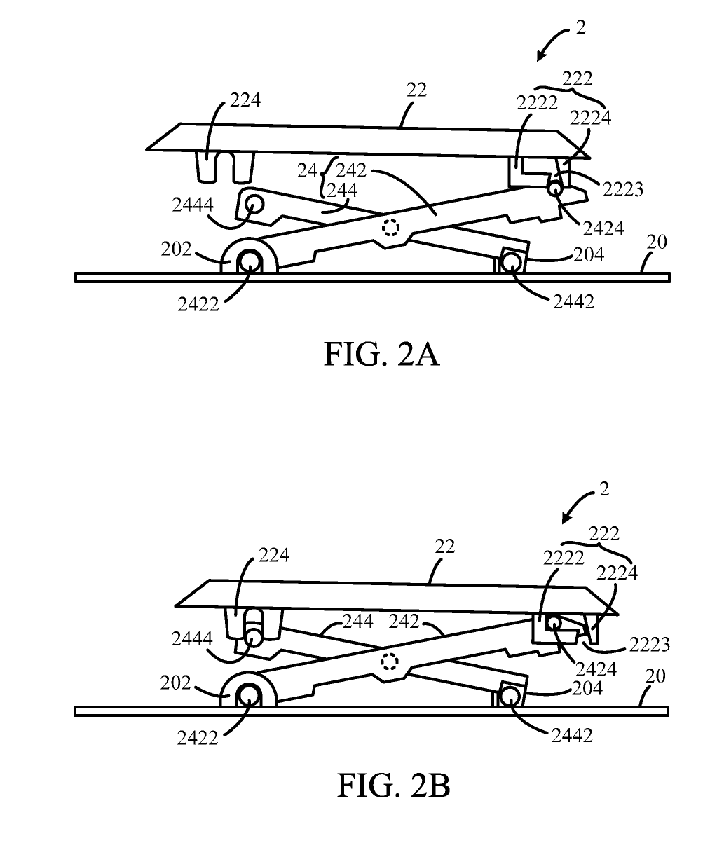

Please refer to FIG. 2. FIG. 2A is a schematic diagram illustrating the first stage of assembling a keycap 22 of a keyswitch 2 to a scissors-like structure 24 according to an embodiment of the invention. The keyswitch 2 includes a base plate 20, the scissors-like supporting structure 24, and the keycap 22. The scissors-like supporting structure 24 includes a first arm member 242 and a second arm member 244. The first arm member 242 has a first axle 2424 and a third axle 2422, and the second arm member 244 has a second axle 2444 and a fourth axle 2442. The first arm member 242 and the second arm member 244 are disposed between the base plate 20 and the keycap 22 and pivotally connected to each other to be X-shaped. The steps of assembling the first arm member 242 and the second arm member 244 on the base plate 20 are firstly assembling the third axle 2422 of the first arm member 242 and the fourth axle 2442 of the second arm member 244 to a first lower pivotal member 202 and a second lower pivotal member 204 of the base plate 20 respectively to become a semi-manufactured goods.

As shown in FIG. 2A, a retaining member 222 is formed at the bottom of the keycap 22, and the retaining member 222 has a retaining portion 2222 and a block 2224. The distal end of the retaining portion 2222 and the distal end of the block 2224 form an opening 2223. When the retaining member 222 compresses toward the first axle 2424 of the first arm member 242 with the opening 2223, the first axle 2424 is limitedly and movably engaged to the retaining member 222 by the elastic deformation of the block 2224, which is the first stage of assembling the keycap 22 to the scissors-like structure 24. And, with the structure of the foregoing retaining member 222, the purpose of vertically assembling the keycap 22 to the scissors-like structure 24 can be achieved.

Please refer to FIG. 2B. FIG. 2B is a schematic diagram illustrating the second stage of assembling the keycap 22 of the keyswitch 2 to the scissors-like structure 24 according to an embodiment of the invention. A pivotal member 224 is formed at the bottom of the keycap 22. After the first axle 2424 of the first arm member 242 compresses toward the opening 2223 and is retained at the retaining member 222, the second arm member 244 can also engage to the pivotal member 224 by compressing the second axle 2444 toward pivotal member 224, which is the second stage of assembling the keycap 22 to the scissors-like structure 24, and the assembling procedures of assembling the keycap 22 to the scissors-like structure 24 are finished.

In order to achieve the foregoing engagement, in an embodiment, the size of the opening 2223 is slightly smaller than the diameter of the first axle 2424 of the first arm member 242. Thereby, when the retaining member 222 compresses toward the first axle 2424 of the first arm member 242 with the opening 2223, the first axle 2424 can compress the retaining portion 2222 and the block 2224 to make the opening 2223 become larger and can be limitedly and movably engaged to the retaining member 222 by the recovered retaining portion 2222 and block 2224.

Furthermore, in order to prevent the first axle 2424 of the first arm member 242 from escaping from the opening 2223, in an embodiment, when the keyswitch 2 is at a lowest pressed position, the first axle 2424 of the first arm member 242 can exactly contact with the block 2224. Of course, when the keyswitch 2 is at a lowest pressed position, the first axle 2424 of the first arm member 242 can also not contact with the block 2224, but the interval between the first axle 2424 and the block 2224 is very small. By disposing the block 2224 at the bottom of the keycap 22 with the foregoing method, the length of the retaining portion 2222 of the retaining member 222 can be shorter than that of a traditional keycap.

It has been known by one having ordinary skill in the art that the stiffness of an object is influenced by the size and the geometric shape of the object. Therefore, if the length of the retaining portion 2222 of the retaining member 222 is shorter, the stiffness of the retaining portion 2222 will be larger. Thereby, compared with prior arts, the damages of the keycap 22 and the scissors-like structure 24 can be reduced during assembling the keycap 22 to the scissors-like structure 24 because of the improved stiffness of the retaining portion 2222 with shorter length.

In an embodiment, the block 2224 is substantially column-shaped. Furthermore, a side of the block 2224 which faces the opening 2223 can be chamfered, such that the first axle 2424 of the first arm member 242 can be easily assembled from the opening 2223 to be engaged to the retaining member 222. Of course, a side of the retaining portion 2222 of the retaining member 222 which faces the opening 2223 can be chamfered. Thereby, the compression force of assembling the keycap 22 to the scissors-like structure 24 can be reduced, such that the damage possibility of the keycap 22 and the scissors-like structure 24 can be reduced.

Please refer to FIG. 2C. FIG. 2C is a partial view illustrating the keycap 22 in FIG. 2A. In an embodiment, the retaining portion 2222 includes a main body 22222 and a cantilever 22224. The main body 22222 is formed at the bottom of the keycap 22, and the cantilever 22224 is protruded from the main body 22222, as shown in FIG. 2A. Thereby, the first axle 2424 of the first arm member 242 can substantially reciprocate parallel to the cantilever 22224 of the retaining portion 2222 after being engaged to the retaining member 222.

It has been known by one having ordinary skill in the art that time and cost can be saved if the number of procedures of manufacturing a product. So, the retaining member 222 which includes the retaining portion 2222 and the block 2224 can be integrally formed with the keycap 22.

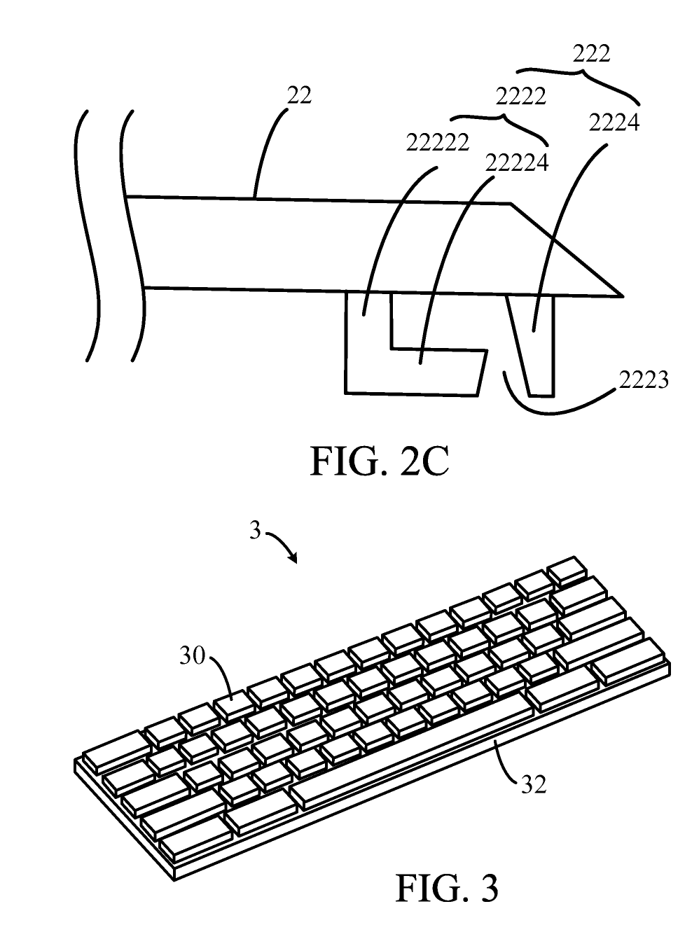

Please refer to FIG. 3. FIG. 3 is a schematic diagram illustrating a keyboard 3 according to an embodiment of the invention. The keyboard includes a plurality of keyswitches 30 and a base plate 32. All of the keyswitches 30 are pivotally disposed on the base plate 32. The structure and the relationships of the inner members of each keyswitch 30 can refer to the foregoing descriptions about the keyswitch 2 with FIG. 2A and FIG. 2B.

It is notable that when the retaining member of each keyswitch compresses toward the first axle with the opening, the first axle is limitedly and movably engaged to the retaining member by the elastic deformation of the block. After the first axle of the first arm member compresses toward the opening and is retained at the retaining member, the second arm member can be engaged to the pivotal member by compressing the second axle toward the pivotal member, as shown in FIG. 2A and FIG. 2B.

Moreover, the keycap can be vertically assembled to the scissors-like structure according to the foregoing assembling procedures of keyswitch. All keyswitches 30 of the keyboard 3 according to the invention can be assembled with the foregoing assembling procedures.

According to the descriptions of the foregoing embodiments of the keyswitch and the keyboard of the invention, it is obvious that a retaining member formed at the bottom of the keycap forms an opening. When the retaining member compresses toward the first axle with the opening, the first axle is limitedly and movably engaged to the retaining member by the elastic deformation of the block. Thereby, the problems caused by the traditional method of assembling the keycap to the scissors-like structure with a tilted angle can be solved. Moreover, the damages of the keycap and the scissors-like structure can be reduced during assembling the keycap to the scissors-like structure because of the improved stiffness of the retaining portion with shorter length. The invention not only can increase the yield rate and reduce the assembling cycle time, but also can benefit convenience and easiness of disassembling, repairing, and cleaning.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as being limited only by the metes and bounds of the appended claims.

What is claimed is:

1. A keyswitch comprising:
a scissors-like supporting structure comprising a first arm member, the first arm member having a first axle; and
a keycap, a retaining member being formed at the bottom of the keycap, the retaining member having a retaining portion and a block, the distal end of the retaining portion and the distal end of the block forming an opening;
wherein when the retaining member compresses toward the first axle with the opening, the first axle is limitedly and movably engaged to the retaining member by the elastic deformation of the block.

2. The keyswitch of claim 1, wherein the size of the opening is slightly smaller than the diameter of the first axle.

3. The keyswitch of claim 2, wherein when the keyswitch is at a lowest pressed position, the first axle exactly contacts with the block.

4. The keyswitch of claim 1, wherein the block is substantially column-shaped.

5. The keyswitch of claim 4, wherein a side of the block which faces the opening is chamfered, such that the first axle is easily assembled from the opening to be engaged to the retaining member.

6. The keyswitch of claim 1, wherein the retaining portion comprises a main body and a cantilever, the main body is formed at the bottom of the keycap, the cantilever is protruded from the main body.

7. The keyswitch of claim 1, wherein the appearance of the retaining portion is substantially reversed-L-shaped.

8. The keyswitch of claim 1, wherein the retaining portion and the keycap are integrally formed.

9. The keyswitch of claim 1, wherein the scissors-like supporting structure comprises a second arm member, the second arm member has a second axle, a pivoting member is formed at the bottom of the keycap, the second arm member is engaged to the pivoting member with the second axle.

10. A keyboard comprising:
a plurality of keyswitches, each keyswitch comprising:
a scissors-like supporting structure comprising a first arm member, the first arm member having a first axle; and
a keycap, a retaining member being formed at the bottom of the keycap, the retaining member having a retaining portion and a block, the distal end of the retaining portion and the distal end of the block forming an opening; and
a base plate, the keyswitches being pivotally disposed on the base plate;
wherein when the retaining member compresses toward the first axle with the opening, the first axle is limitedly and movably engaged to the retaining member by the elastic deformation of the block.

11. The keyboard of claim 10, wherein the size of the opening of the each keyswitch is slightly smaller than the diameter of the first axle.

12. The keyboard of claim 11, wherein when the each keyswitch is at a lowest pressed position, the first axle exactly contacts with the block.

13. The keyboard of claim 10, wherein the block of the each keyswitch is substantially column-shaped.

14. The keyboard of claim 13, wherein a side of the block of the each keyswitch which faces the opening is chamfered, such that the first axle is easily assembled from the opening to be engaged to the retaining member.

15. The keyboard of claim 10, wherein the retaining portion of the each keyswitch comprises a main body and a cantilever, the main body is formed at the bottom of the keycap, the cantilever is protruded from the main body.

16. The keyboard of claim 10, wherein the appearance of the retaining portion of the each keyswitch is substantially reversed-L-shaped.

17. The keyboard of claim 10, wherein the retaining portion of the each keyswitch and the keycap are integrally formed.

18. The keyboard of claim 10, wherein the scissors-like supporting structure of the each keyswitch comprises a second arm member, the second arm member has a second axle, a pivoting member is formed at the bottom of the keycap, the second arm member is engaged to the pivoting member with the second axle.
